(19) United States
(12) Patent Application Publication
(10) Pub. No.: US 2009/0217076 A1
(43) Pub. Date: Aug. 27, 2009

(54) PERSONAL IDENTIFICATION MEDIUM, DISPLAY METHOD FOR A PERSONAL IDENTIFICATION MEDIUM, TIME AND ATTENDANCE MANAGEMENT SYSTEM, AND CUSTOMER INFORMATION MANAGEMENT SYSTEM

(75) Inventors: Kenji Okuhara, Matsumoto-shi (JP); Masashi Aonuma, Shiojiri-shi (JP); Yukie Takeuchi, Sakaki-machi (JP); Junichi Otsuka, Chikuma-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/371,405

(22) Filed: Feb. 13, 2009

(30) Foreign Application Priority Data
Feb. 14, 2008 (JP) 2008-032791
Mar. 21, 2008 (JP) 2008-073057

(51) Int. Cl. G06F 1/14; G06F 13/10

(52) U.S. Cl. 713/600; 710/33

(57) ABSTRACT

A personal identification medium enables easily confirming specific information. A time and attendance management system and a customer information management system both use the personal identification medium. An individual information storage unit 41 stores personal information related to an individual. A display 35 displays the personal information. A communication unit 31 receives predetermined information by wireless communication from an external device 3 installed in a specified location. The display 35 displays or stops displaying the personal information when triggered by reception of the predetermined information when entering or leaving the specified location.

This application claims priority under 35 U.S.C. § 119 to Japanese Patent Application Nos: 2008-032791 filed on Feb. 14, 2008, and 2008-073057 filed on Mar. 21, 2008, the entire disclosure of which are expressly incorporated by reference herein.

### BACKGROUND OF THE INVENTION

1. Field of Invention

The present invention relates to personal identification media that can display individual information, a display method for personal identification media, and a time and attendance management system and a customer information management system that use the personal identification media.

2. Description of Related Art

Electronic attendance management systems that use employee identification cards (such as magnetic stripe cards or ID cards) as a medium identifying individual workers to manage worker (employee) attendance (including clock-in and clock-out times, working time, and worker absences) are known from the literature. Such attendance management systems include a management computer and a card reader. When an employee swipes his employee identification card through the card reader and the time the card is swiped is input (equivalent to clocking in with a conventional timecard), a record including the employee code registered in the swiped card, the card, and the time is sent to the management server. This enables centralized management of time and attendance for all employees. See, for example, Japanese Unexamined Patent Appl. Pub. JP-A-H09-115021.

Membership card systems that are used in retail stores, for example, to issue membership cards as a medium for identifying individual users and provide such customer services as issuing coupons to members (customers) that use a membership card are also known from the literature. See, for example, Japanese Unexamined Patent Appl. Pub. JP-A-2000-335151. This membership card system is composed of membership cards and a card reader/writer for reading the membership cards and writing information to the membership cards. A member code that identifies a particular customer is recorded on each card. When the customer uses the membership card, the card reader/writer reads the member code and records a customer transaction record or membership benefit information based on the member code on the face of the membership card.

A problem with the attendance management system taught in JP-A-H09-115021 is that because employee time information (work time, for example) is managed on a central server, employees are unable to freely check their own time information. This means the employees are unable to know if their own time information has been accurately recorded. More particularly, shift workers such as part-time workers and temporary workers that are paid differently according to the work shift often want to check how many days (hours) they have worked because earnings are determined by how many days or hours are worked in a single month.

A problem with the membership card system taught in JP-A-2000-335151 is that because membership cards are issued separately by each business (or each store), an individual customer that has registered as a member with a plurality of companies must carry around a plurality of membership cards, and keeping track of multiple cards becomes difficult. Particularly when the customer carries the cards in a wallet, numerous cards makes finding a particular card time-consuming.

### SUMMARY OF THE INVENTION

A first aspect of the present invention is a personal identification medium that enables easily verifying particular personal information.

Another aspect of the invention is a display method for the personal identification media.

Another aspect of the invention is a time and attendance management system and a customer information management system that use the personal identification media.

A first aspect of the invention is a personal identification medium having a personal information storage unit that stores personal information including information relating to an individual; a display unit that displays the personal information; and a reception unit that receives information by contactless communication from an external device, and displays or stops displaying the personal information when triggered by receiving specific information from the external device.

Another aspect of the invention is a display method for a personal identification medium, including steps of: storing personal information including information relating to an individual in a personal information storage unit; receiving information by contactless communication from an external device by means of a reception unit; displaying the personal information based on the received information on a display unit; and displaying or not displaying the personal information when triggered by receiving specific information from the external device.

The personal identification medium and display method according to this aspect of the invention can display or stop displaying personal information stored in the personal identification medium when triggered by specific information that is received when entering and leaving a predetermined location. A user can thus easily confirm personal information by simply entering or leaving the predetermined location without performing any specific operation. User convenience is good because the personal information can, for example, be displayed when required and not displayed when not required without intervention by the user.

In a personal identification medium according to another aspect of the invention the external device is installed at a prescribed location, and is used to record the time (input the time) when an individual clocks in and when an individual clocks out (arrives at work and leaves work); the reception unit receives at least clock-in time or clock-out time information from the external device, and includes a clock-in/clock-out time storage unit that stores the received clock-in time or clock-out time information in addition to the personal information; and the display unit displays or stops displaying the clock-in time or clock-out time when triggered by the reception unit receiving the clock-in time or clock-out time as the specific information.

The personal identification medium according to this aspect of the invention receives clock-in time and clock-out time information from an external device, and displays or stops displaying the stored time information and personal information on the display unit when triggered by receiving this time clock information.

More particularly, a history of the time at work that is centrally managed by a time and attendance management server and generally cannot be known without accessing the time and attendance management server can thus be displayed on the personal identification medium that is carried by each employee (individual). Employees can thus easily confirm their own time and attendance information (history of clock-in and clock-out times) at a glance, and can know if their own time and attendance information is accurately recorded. More particularly, shift workers such as part-time workers and temporary workers that are paid differently according to the work shift need to know how many days (hours) they have worked because earnings are determined by how many days or hours are worked in a single month. In this situation, using the personal identification medium according to at least one embodiment of the present invention enables easily confirming time and attendance management information.

In a personal identification medium according to another aspect of the invention the display unit displays at least the clock-in time when triggered by receiving the clock-in time, and stops displaying the displayed content when triggered by receiving the clock-out time.

In this aspect of the invention clocking in to work triggers displaying the time and attendance management information and personal information, and clocking out from work triggers clearing this information from the display. The time and attendance management information and personal information are thus displayed on the personal identification medium while the user is at work, but this information is erased (cleared) from the display when leaving the workplace. This prevents leaking the time and attendance management information and personal information if, for example, the personal identification medium is lost when not at work.

A personal identification medium according to another aspect of the invention preferably also has an operating unit for changing the content displayed by the display unit.

This aspect of the invention enables changing the content displayed on the personal identification medium. As a result, if time and attendance management information is displayed and all of the time and attendance management information cannot be presented at one time on the display, the user can change the displayed content by scrolling through the information, for example, and an employee can therefore reliably confirm the complete time and attendance management information record.

In a personal identification medium according to another aspect of the invention the personal information includes member information for identifying a member in a company; the personal information storage unit stores the member information linked to one or more company codes for identifying the company; and the display unit displays or stops displaying the member information linked to the company code when triggered by the reception unit receiving the company code for any one of the one or more companies as the specific information.

When a company code is received from the external device in this aspect of the invention, the personal identification medium displays or does not display member information linked to the company code on the display unit. Because member information corresponding to the received company code can be displayed, that is, the displayed content (member information content) can be changed according to the company code, a single personal identification medium can be used in common at a plurality of companies. For example, if the personal identification medium is used as a membership card and a single customer is a member of a plurality of companies, the company code and member information (such as membership number and name) can be stored linked together in the personal identification medium for a plurality of companies. The customer therefore does not need to carry a plurality of membership cards as is necessary with the related art, and managing membership cards is therefore easier for the customer. Furthermore, because a single personal identification medium can be used by a plurality of companies, each company does not need to issue a separate membership card, and the cost of issuing membership cards is therefore reduced for the companies.

A personal identification medium according to another aspect of the invention also has a code detection unit that determines whether or not a company code is contained in the information received by the reception unit, and the display unit displays the member information when the code detection unit determines that a company code exists, and does not display the member information when the code detection unit determines that a company code does not exist.

The personal identification medium according to this aspect of the invention thus determines if the received company code exists, and displays the member information related to the company code if the company code exists. If the company code does not exist, member information is not displayed and a message indicating that the personal identification medium cannot be used at that company is displayed. The customer can thus easily know if the personal identification medium can be used at a particular company.

A personal identification medium according to another aspect of the invention preferably also has a code generating unit that generates an encoded symbolic image, and the member information includes a member number assigned to each member and a code type identifying the type of code. The code generating unit generates the symbolic image from the member number based on the code type; and the display unit displays the generated symbolic image as at least a part of the member information.

In this aspect of the invention a linear barcode, two-dimensional barcode, or other symbolic image is generated based on the member number and code type that are stored as member information. This enables quickly and easily reading a membership number using a common linear barcode or two-dimensional barcode reader, and a special reading device is therefore not needed.

A personal identification medium according to another aspect of the invention preferably also has an event information storage unit that receives and stores event information related to the company from the external device, and the display unit displays the event information when triggered by reception of the company code.

This aspect of the invention enables receiving and displaying event information for a particular company. This enables the customer to easily acquire event information for the company such as announcements of special sales and changes in business hours or days when the business is closed.

Yet further preferably, the personal identification medium is a card type medium.

In this aspect of the invention the personal identification medium is card-shaped. This enables the personal identification medium to be used as an employee identification card or preferred customer card without any sense of novelty, and the personal identification medium is thus convenient.

In a personal identification medium according to another aspect of the invention the display unit is preferably electronic paper.

In this aspect of the invention the display unit of the personal identification medium is rendered using electronic paper. Because the display is electronic paper, a minimal amount of power is required only when rewriting the displayed content, no power is consumed to maintain the displayed content, and little power is therefore needed to display information.

Another aspect of the invention is a time and attendance management system including the personal identification medium described above and a time and attendance management device that transmits at least the clock-in time and clock-out time for an individual as the external device.

The time and attendance management system according to this aspect of the invention sends clock-in time and clock-out time information from the time and attendance management device to a personal identification medium storing personal information, and stores the time information in nonvolatile storage in the personal identification medium. The stored history of hours worked and the personal information can be displayed and cleared from the display of the personal identification medium appropriately. Each employee can therefore easily know the employee's own time and attendance information (history of clock-in and clock-out times), and can know if the work history has been correctly recorded.

Another aspect of the invention is a customer information management system including the personal identification medium described above and a customer information management device that transmits at least the company code as the external device.

The customer information management system according to this aspect of the invention can display or not display member information stored in the personal identification medium according to the company code received from a customer information management device, and can change the displayed content (member information content) according to the received company code. As a result, a single personal identification medium can be used at a plurality of companies by installing a customer information management device in different companies.

Other objects and attainments together with a fuller understanding of at least one embodiment of the invention will become apparent and appreciated by referring to the following description and claims taken in conjunction with the accompanying drawings.

### BRIEF DESCRIPTION OF THE DRAWINGS

FIG. 1 is a block diagram of a time and attendance management system according to a first embodiment of the invention.

FIG. 2 describes the display content of an employee identification card according to a first embodiment of the invention.

FIG. 3 describes displaying and not displaying the displayed content of the employee identification card according to the first embodiment of the invention.

FIG. 4 is a flow chart describing a process for displaying personal information and the time and attendance history on the employee identification card according to the first embodiment of the invention.

FIG. 5 is a flow chart describing a process for clearing personal information and the time and attendance history from the employee identification card according to the first embodiment of the invention.

FIG. 6 is a block diagram of a customer information management system according to a second embodiment of the invention.

FIG. 7 shows an example of a member information table in the second embodiment of the invention.

FIG. 8A describes an example of the content displayed on a membership card according to the second embodiment of the invention.

FIG. 8B describes another example of the content displayed on a membership card according to the second embodiment of the invention.

FIG. 9 is a flow chart of a process for displaying member information and event information on a membership card according to the second embodiment of the invention.

### DESCRIPTION OF PREFERRED EMBODIMENTS

Embodiment 1

A preferred embodiment of a personal identification medium and a time and attendance management system according to a first embodiment of the present invention is described below with reference to the accompanying figures. This embodiment uses an employee identification card as an example of a personal identification medium according to at least one embodiment of the present invention.

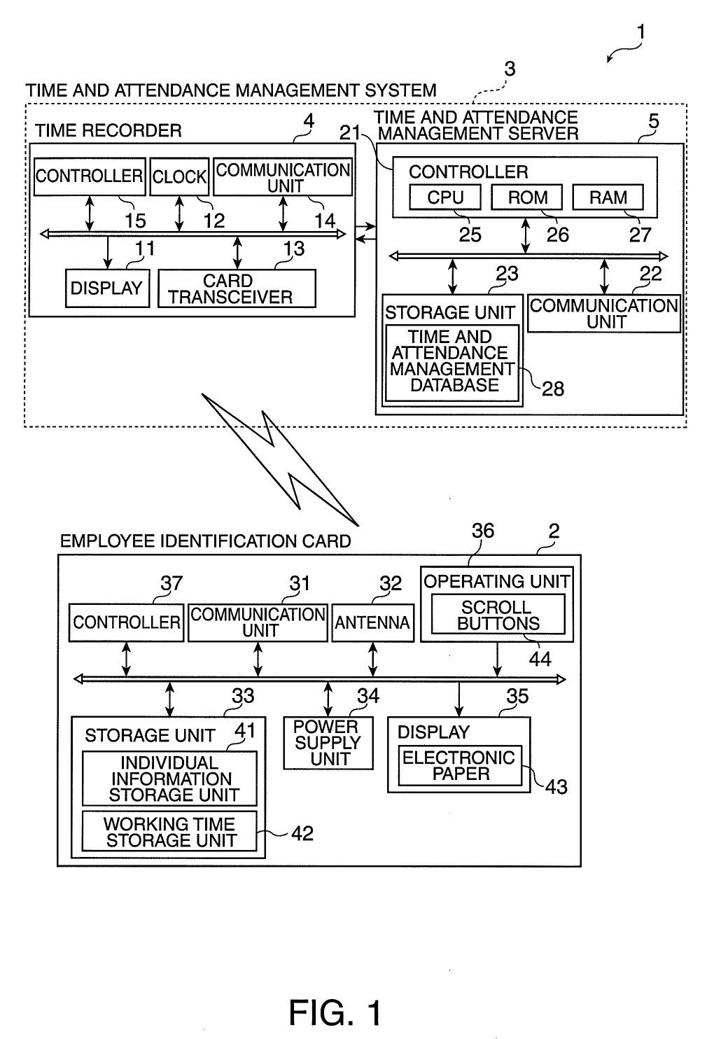

As shown in FIG. 1, a time and attendance management system 1 according to this first embodiment of the invention includes employee identification cards 2 (personal identification media) that are used by individual employees as an electronic time cards to track hours worked, and a time and attendance management system 3 (external device) for time and attendance management for all employees.

The time and attendance management system 3 includes a time recorder 4 that reads a employee identification card 2 and inputs the time each card is read, and a time and attendance management server 5 that manages the time and attendance management information for each employee.

The time recorder 4 includes a display 11, a clock 12, a card transceiver 13, a communication unit 14, and a controller 15 that controls the other parts.

The display 11 displays the current time and messages for employees. The clock 12 is a real-time clock that is built in to the time recorder 4 to keep time. In this embodiment of the invention the clock 12 is used to acquire the time (the time when an employee clocks in or out using the employee identification card 2, referred to below as the “ID information read time”) when ID (Identity Document) information is read from the employee identification card 2. The controller 15 synchronizes the time with the time and attendance management server 5 at a predetermined time interval and adjusts the time of the clock 12 to the time of the time and attendance management server 5.

The card transceiver 13 communicates with the employee identification card 2 by means of wireless proximity communication (contactless communication). The communication unit 14 communicates with the time and attendance management server 5. When an employee clocks in or out using the employee identification card 2, the controller 15 reads the ID information from the employee identification card 2 through the card transceiver 13 (that is, receives the ID information from the employee identification card 2). The controller 15 sends the ID information read from the employee identification card 2 and the ID information read time through the communication unit 14 to the time and attendance management server 5. The controller 15 receives the ID information read time (the clock-in time or clock-out time) sent from the time and attendance management server 5 through the communication unit 14. The controller 15 sends the ID information read time (clock-in time or clock-out time) through the card transceiver 13 to the employee identification card 2.

The time and attendance management server 5 includes a controller 21, communication unit 22, storage unit 23, and other hardware components of a typical personal computer.

The controller 21 includes a CPU 25, ROM 26, and RAM 27, and controls the time and attendance management server 5. The ROM 26 stores control data and the control program run by the CPU 25 to execute various processes. RAM 27 is used as working memory when the CPU 25 executes the various processes.

The communication unit 22 communicates with the time recorder 4. The controller 21 receives the ID information from the employee identification card 2 and the ID information read time from the time recorder 4 through the communication unit 22. The controller 21 sends the clock-in time or clock-out time for the ID information registered in the time and attendance management database 28 described below to the time recorder 4.

The storage unit 23 stores the time and attendance management database 28 in which time and attendance management information for each employee is recorded. The time and attendance management information includes the daily clock-in time and clock-out time and the hours worked for each employee.

The controller 21 identifies the employee based on the ID information in the employee identification card 2 received from the time recorder 4, and records the received ID information read time as the clock-in time or clock-out time in the time and attendance management database 28. The controller 21 also calculates the time worked by the employee from the clock-in and clock-out times.

The employee identification card 2 includes a communication unit 31 (receiver), antenna 32, storage unit 33, power supply unit 34, display 35, operating unit 36, and controller 37 that controls these other parts.

The communication unit 31 communicates with the time recorder 4 by wireless proximity communication (contactless communication).

When an employee clocks in or out using the employee identification card 2, the controller 37 controls the communication unit 31 to detect an ID information read request sent from the time recorder 4 through the antenna 32.

Triggered by detecting this request, the controller 37 sends the ID information to the time recorder 4. The controller 37 also receives the clock-in time or clock-out time from the time recorder 4 whenever an employee clocks in or out.

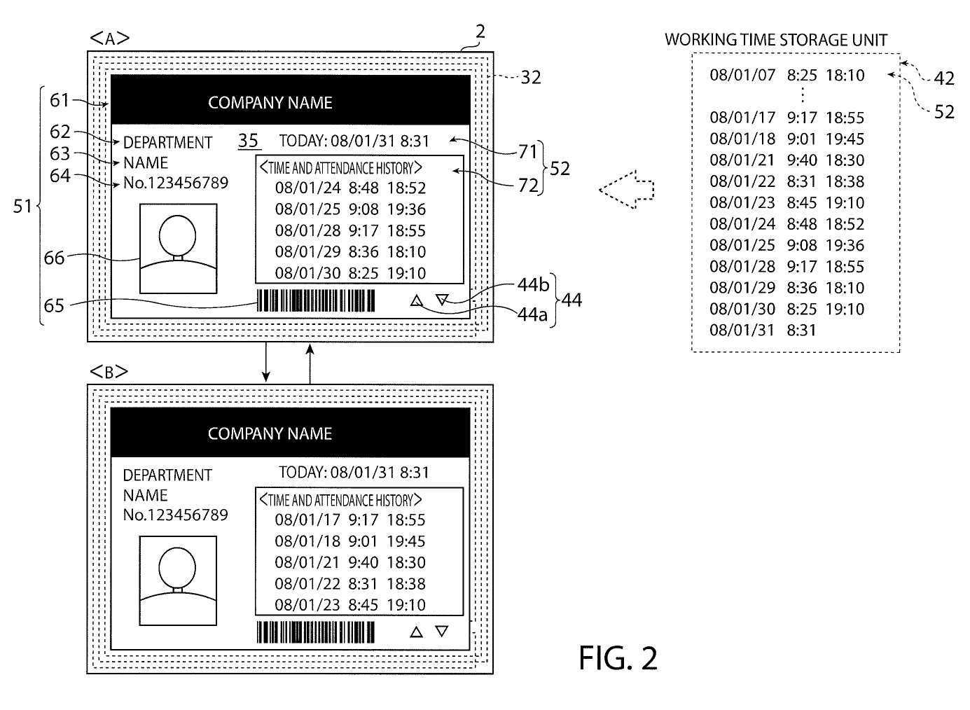

The storage unit 33 is a nonvolatile storage device such as nonvolatile memory, and includes an individual information storage unit 41 and a working time storage unit 42 (clock in/out storage unit) Personal information 51 for the employee to whom the employee identification card 2 is issued is stored in the individual information storage unit 41. As shown in FIG. 2, the personal information 51 includes, for example, the company name 61, department 62, name 63, ID information 64, barcode 65, and picture 66. The clock-in and clock-out times are stored in the working time storage unit 42. The clock-in and clock-out times are cumulatively stored each time the employee clocks in or out. The employee identification card 2 may be configured to automatically delete data starting from the oldest data if the clock-in and clock-out time data stored in the working time storage unit 42 exceeds a predetermined amount.

The power supply unit 34 is a battery for operating the employee identification card 2 and supplying power to the other parts. Electronic paper is used for the display 35, which displays the employee's personal information 51 and time and attendance management information (the clock-in time 71 for the current day and the clock-in/clock-out time history through the previous day 72, together referred to as the “time and attendance management history 52” below) as shown in FIG. 2. Because the display 35 is electronic paper 43, a minimal amount of power is required only when rewriting the displayed content, no power is consumed to maintain the displayed content, and little power is therefore needed to display information.

The operating unit 36 is used to change the content displayed on the display 35, and has scroll buttons 44 for scrolling the displayed content up and down. This enables the user to change (scroll through) the displayed information if the entire time and attendance management history 52 (the clock-in/clock-out time history through the previous day 72) will not fit in one screen. The operating unit 36 may be rendered in unison with the display 35 if a touch panel is used for the display 35, or it may be separate from the display 35.

An example of the content displayed on the employee identification card 2 is described next with reference to FIG. 2. FIG. 2 shows an example in which the time and attendance management history 52 (clock-in and clock-out times) for the previous one month period of time is stored in the working time storage unit 42. As shown in FIG. 2, the company name 61, employee's department 62, employee name 63, employee ID (ID information) 64, a barcode 65 representing the employee ID, and a picture 66 of the employee's face are displayed as the personal information 51 on the display 35 of the employee identification card 2, and the clock-in time for the current day 71 and the clock-in/clock-out time history through the previous day 72 are displayed as the time and attendance management history 52. If the entire clock-in/clock-out time history through the previous day 72 cannot be presented at once on the display 35, the employee can use the scroll buttons 44 to change the displayed content. For example, only a part (the five day period including the previous day) of the clock-in/clock-out time history through the previous day 72 can be displayed in the example shown in FIG. 2A. The scroll-up button 44a can be used in this situation to change to a display as shown in FIG. 2B to display the clock-in/clock-out time history 72 for a different period of days. The scroll-down button 44b can also be used to scroll from the content shown in FIG. 2B to the content shown in FIG. 2A. The employee can therefore confirm the entire time and attendance management history 52.

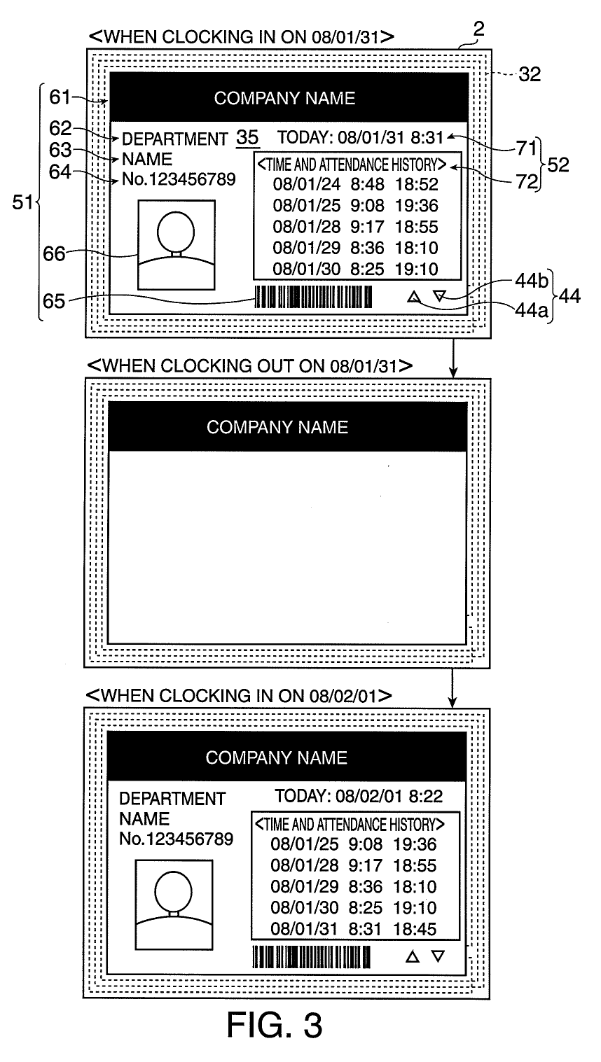

The personal information 51 and time and attendance management history 52 are displayed when the employee clocks in. More specifically, triggered by this clock-in operation, the controller 37 reads the personal information 51 and time and attendance management history 52 from the storage unit 33 and displays the read information on the display 35. The employee clocking out also triggers clearing the content displayed on the display 35 (that is, the time and attendance management history 52 and all or part of the personal information 51) so that nothing is displayed as shown in FIG. 3. The personal information 51 and time and attendance management history 52 are thus displayed on the employee identification card 2 while the employee is at work, but the display is cleared when the employee leaves. This prevents leaking the personal information 51 and time and attendance management history 52 if the employee identification card 2 is lost while the employee is not at work.

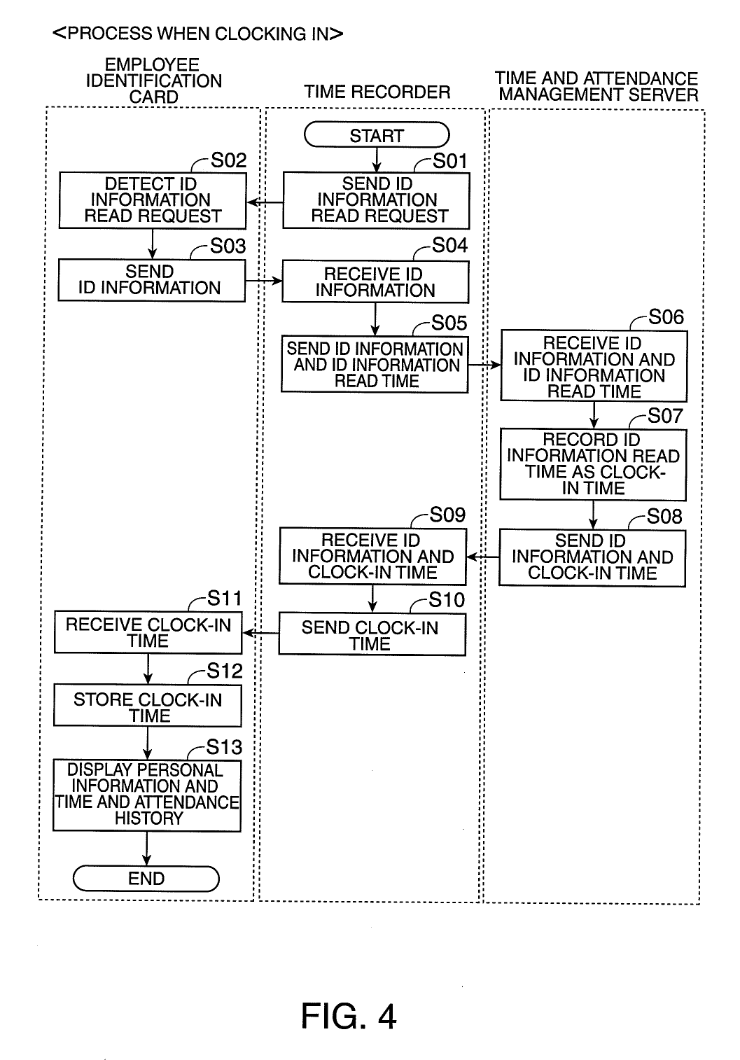

A process for displaying the personal information 51 and time and attendance management history 52 on the employee identification card 2 is described next with reference to the flow chart in FIG. 4. In this example the employee uses the employee identification card 2 to clock in.

The time recorder 4 continuously sends an ID read request in order to read the ID information from an employee identification card 2 (S01). When the employee passes the employee identification card 2 over the time recorder 4 (or the employee (employee identification card 2) enters a predetermined area), the employee identification card 2 detects the ID read request from the time recorder 4 (S02). Triggered by detecting the ID read request, the employee identification card 2 sends the ID information stored in the individual information storage unit 41 to the time recorder 4 (S03)

When the ID information is received (S04), the time recorder 4 sends the ID information and the ID information read time, which is the time the ID information was received, to the time and attendance management server 5 (S05).

When the ID information and ID information read time are received (S06), the time and attendance management server 5 records the received ID information read time in the time and attendance management database 28 as the clock-in time of the employee identified by the ID information (S07). The time and attendance management server 5 then sends the ID information and clock-in time to the time recorder 4 (S08).

The time recorder 4 receives the ID information and clock-in time (S09). The time recorder 4 then identifies the employee identification card 2 identified by the received ID information, and sends the clock-in time to the employee identification card 2 (S10). The employee identification card 2 receives the clock-in time (S11) and stores the clock-in time in the storage unit 33 (S12) .The employee identification card 2 then reads the personal information 51 and time and attendance management history 52 (clock-in time for the current day 71 and clock-in/clock-out time history through the previous day 72) from the storage unit 33, and displays the information on the display 35 (S13).

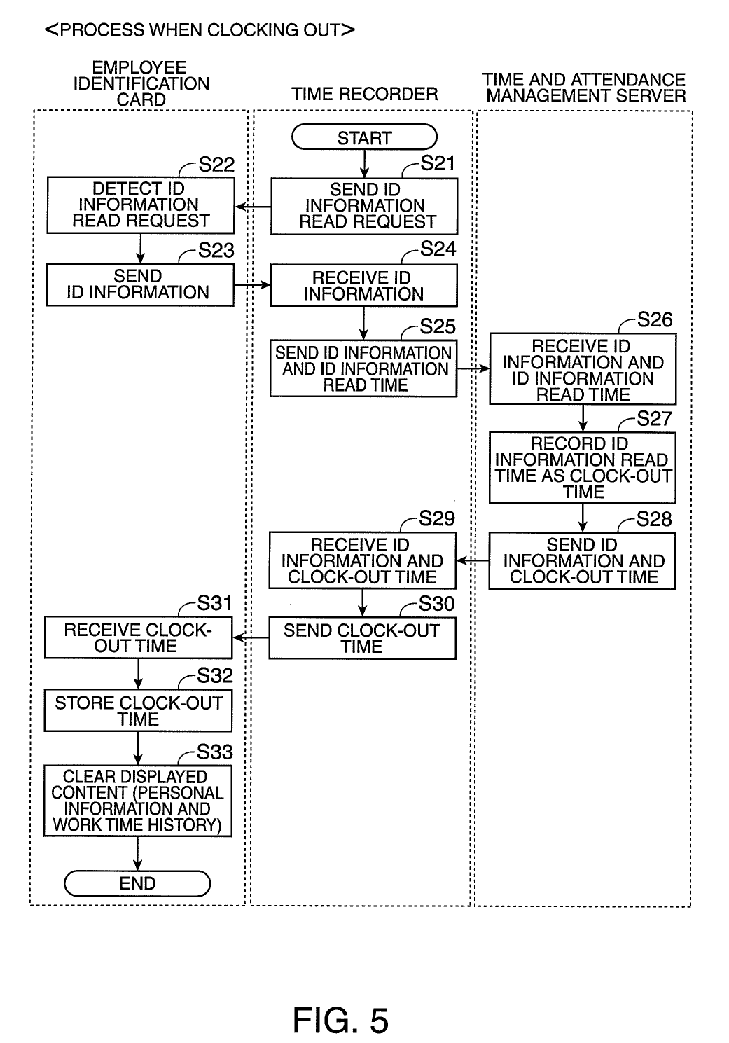

A process whereby the personal information 51 and time and attendance management history 52 displayed on the employee identification card 2 are cleared is described next with reference to the flow chart in FIG. 5. In this example the employee uses the employee identification card 2 to clock out, and the personal information 51 and time and attendance management history 52 (clock-in time for the current day 71 and clock-in/clock-out time history through the previous day 72) are displayed on the display 35 of the employee identification card 2.

The time recorder 4 continuously sends an ID read request in order to read the ID information from an employee identification card 2 (S21). When the employee passes the employee identification card 2 over the time recorder 4 (or the employee (employee identification card 2) enters a predetermined area), the employee identification card 2 detects the ID read request from the time recorder 4 (S22). Triggered by detecting the ID read request, the employee identification card 2 sends the ID information stored in the individual information storage unit 41 to the time recorder 4 (S23).

When the ID information is received (S24), the time recorder 4 sends the ID information and the ID information read time, which is the time the ID information was received, to the time and attendance management server 5 (S25).

When the ID information and ID information read time are received (S26), the time and attendance management server 5 records the received ID information read time in the time and attendance management database 28 as the clock-out time of the employee identified by the ID information (S27). The time and attendance management server 5 then sends the ID information and clock-in time to the time recorder 4 (S28).

The time recorder 4 receives the ID information and clock-out time (S29). The time recorder 4 then identifies the employee identification card 2 identified by the received ID information, and sends the clock-out time to the employee identification card 2 (S30). The employee identification card 2 receives the clock-out time (S31) and stores the clock-out time in the storage unit 33 (S32). The employee identification card 2 then clears the display 35 (S33). To confirm that the clock-out time was written, the clock-out time may be temporarily displayed before clearing the display.

An employee identification card 2 according to this embodiment of the invention that stores personal information 51 receives clock-in (arrival) and clock-out (departure) times from a time and attendance management server 5, and stores the clock-in and clock-out times in nonvolatile memory in the employee identification card 2. The stored personal information 51 and clock-in/clock-out history can also be displayed or not displayed on the display 35 of the employee identification card 2. Time and attendance management information (time and attendance management history 52) that is centrally managed by a time and attendance management server 5 and generally cannot be known without accessing the time and attendance management server 5 can thus be displayed on the employee identification card 2 carried by each employee (individual) Employees can thus easily confirm their own time and attendance information, and can know if their own time and attendance information is accurately recorded.

It should be noted that while this embodiment of the invention is described using an employee identification card 2 as an example of a personal identification medium, the invention is not so limited. A cell phone or other mobile data device may be used as the personal identification medium, for example.

Where content is displayed and the position of the operating unit 36 (scroll buttons 44) in the foregoing embodiment are also used only as examples, and the invention is not so limited.

The foregoing embodiment is also described as simply clearing the content displayed on the display 35 of the employee identification card 2 so that the display 35 goes blank when the employee clocks out, but the invention is not so limited. Alternatively, for example, all personal information 51 other than the ID information and the time and attendance management information (time and attendance management history 52) stored in the storage unit 33 of the employee identification card 2 may be deleted when the employee clocks out. In this situation the personal information 51 and time and attendance management information are read from the time and attendance management server 5 when the employee clocks in so that the information can be displayed on the employee identification card 2.

Messages for employees may also be displayed on the employee identification card 2. In this situation a database for managing such employee messages is maintained on the time and attendance management server 5, and the message can be sent with the clock-in time to the employee identification card 2 when an employee clocks in.

It will be obvious to one with ordinary skill in the related art that the invention is not limited to the foregoing embodiment and the hardware configuration and the processes of the time and attendance management system 1 described above can be varied and improved in many ways without departing from the scope of the accompanying claims.

Embodiment 2

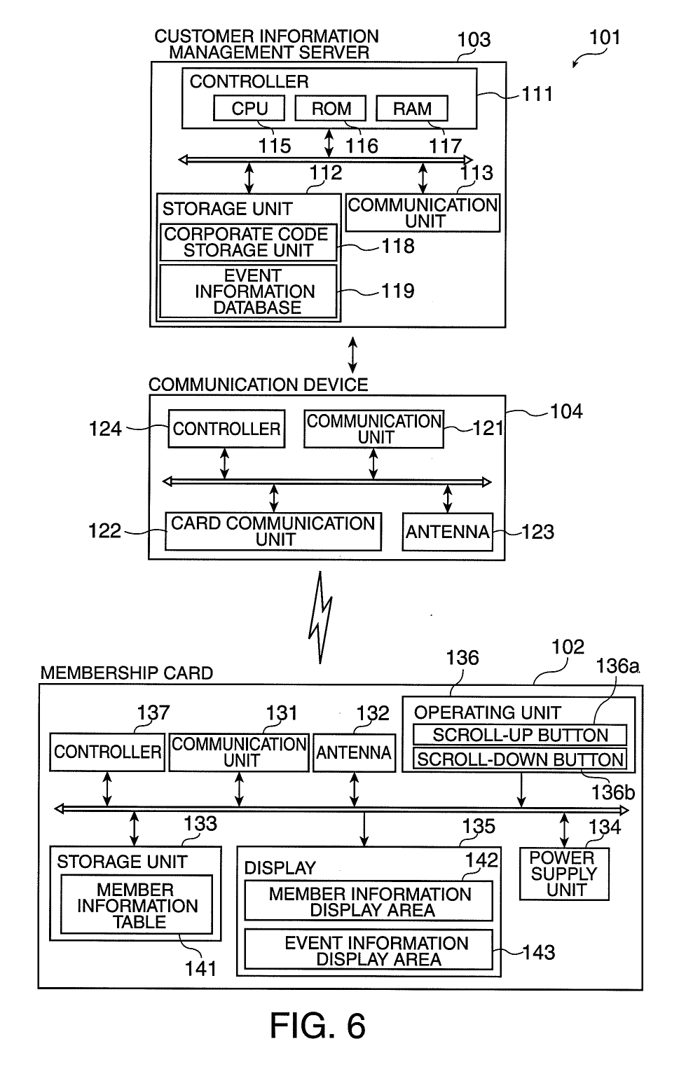

A preferred embodiment of a personal identification medium and a customer information management system according to a second embodiment of the present invention is described below with reference to FIG. 6 to FIG. 9. This embodiment uses a membership card such as issued by mass merchandisers and specialty retail stores as an example of a personal identification medium according to at least one embodiment of the present invention.

FIG. 6 is a block diagram showing the configuration of a customer information management system 101 according to a second embodiment of the invention. The customer information management system 101 according to this embodiment of the invention includes membership cards 102 (personal identification media) carried by customers, a customer information management server 103 for managing member information, and a communication device 104 for communicating with the membership card 102 and customer information management server 103. Note that the customer information management device (external device) in the accompanying claims is rendered by the customer information management server 103 and the communication device 104. In this second embodiment of the invention the customer information management server 103 and communication device 104 are deployed in each store (company) that uses the membership cards 102.

The customer information management server 103 includes a controller 111, storage unit 112, communication unit 113, and other hardware components of a typical personal computer.

The controller 111 includes a CPU 115, ROM 116, and RAM 117, and controls the customer information management server 103. The ROM 116 stores control data and the control program run by the CPU 115 to execute various processes. RAM 117 is used as working memory when the CPU 115 executes the various processes.

The storage unit 112 includes a corporate code storage unit 118 and event information database 119.

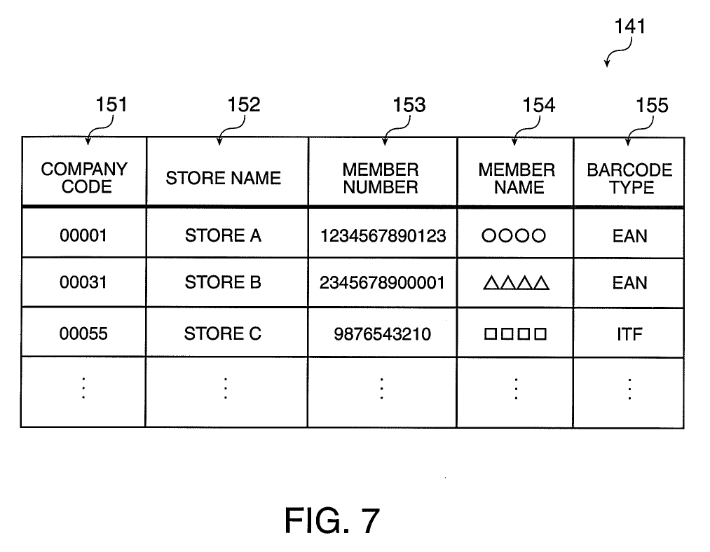

The corporate code storage unit 118 stores company codes 151 (see FIG. 7) uniquely identifying a particular store (company)

The event information database 119 stores event information particular to a store (such as special sales information and announcements about changes in store hours or days closed).

The communication unit 113 communicates with the communication device 104.

The controller 111 controls the communication unit 113 and sends the company code 151 and event information to the communication device 104. The company codes 151 are preassigned by a card operating company (a third-party organization, not shown in the figures) that issues the membership cards 102 of at least one embodiment of the invention.

The communication device 104 is installed at a specific location in the store, and includes a communication unit 121, card communication unit 122, antenna 123, and a controller 124 that controls the other parts of the communication device 104.

The communication unit 121 communicates with the customer information management server 103.

The controller 124 receives the company code 151 and event information from the customer information management server 103 through the communication unit 121.

The card communication unit 122 talks with the membership card 102 by wireless proximity communication (contactless communication).

The controller 124 controls the card communication unit 122 to receive the company code 151 and event information through the antenna 123.

The communication device 104 may typically be installed at the entrance to the store or the checkout counter. If installed at the entrance to a store, the communication device 104 may be part of a theft prevention system that is installed at points of egress for detecting product theft.

The membership card 102 is a card that can be commonly used at a plurality of stores, and includes a communication unit 131 (reception unit and event information reception unit), an antenna 132, a storage unit 133 (personal information storage unit, event information storage unit), a power supply unit 134, display 135, operating unit 136, and controller 137 that controls these other parts.

The communication unit 131 communicates with the communication device 104 by wireless proximity communication (contactless communication). When the membership card 102 enters the range within which signals from the communication device 104 can be received, the controller 137 controls the communication unit 131 to receive the company code 151 and event information through the antenna 132.

The storage unit 133 stores a member information table 141 and the received event information in nonvolatile storage.

The member information table 141 is a data table for storing the company codes 151 and member information related to each company code 151, and stores information for one or more stores (companies) (see FIG. 7). The member information includes the store name 152 (company name), member number 153, member name 154, and barcode type 155.

The company code 151 is an identifier that uniquely identifies each store, and the member number 153 is an identifier that uniquely identifies the customers (membership cards 102) of each store.

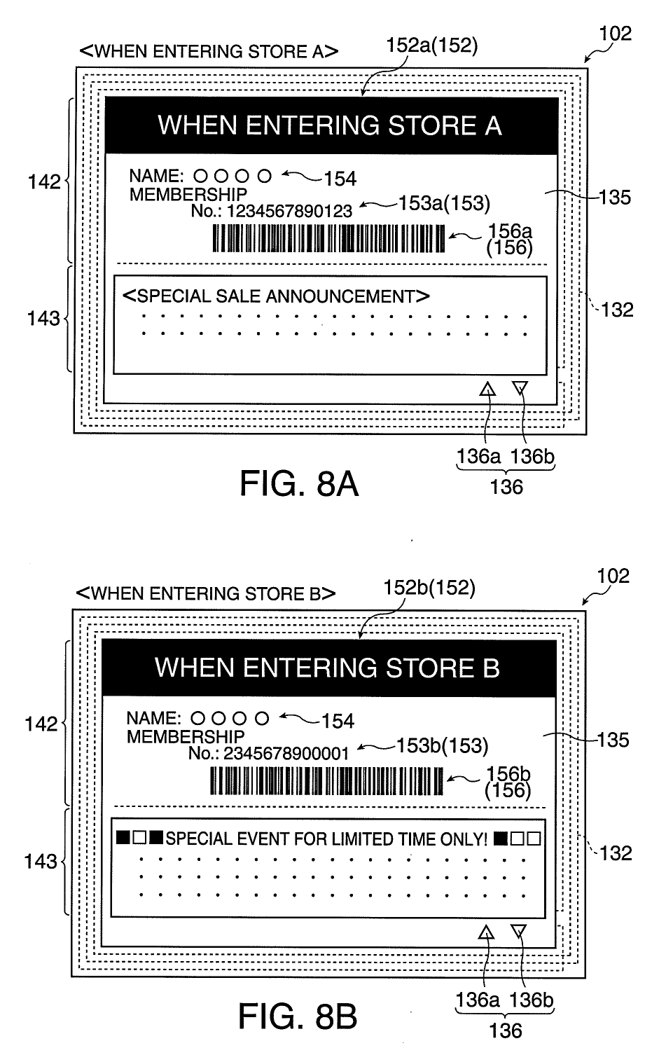

The barcode type 155 identifies the type of barcode 156 (such as EAN (European Article Number), ITF (Interleaved Two of Five)) when the barcode 156 unique to a membership card 102 is generated (see FIG. 8). The barcode 156 may also be a two-dimensional barcode. These are collectively referred to herein as symbolic images.

Note that FIG. 7 shows an example storing information for stores A, B, and C, but the invention is not so limited and information for more companies (stores) may be stored. Furthermore, the company code 151 and member number 153 shown in the figures are shown for example only, and the number of digits in the company code 151 and the method of assigning numbers may be configured as needed for identifying the intended companies. The number of digits in the member number 153 and the method of generating the member number 153 may also be configured as needed according to the barcode type 155 and the ability to uniquely identify each customer.

The power supply unit 134 is a battery for operating the membership card 102 and supplying power to the other parts.

The display 135 includes a member information display area 142 and an event information display area 143.

The store name 152, member name 154, member number 153, and barcode 156 are displayed in the member information display area 142.

The barcode type 155 represents the member number 153 encoded according to the barcode type 155, and is generated by the controller 137.

Information about events at the store is displayed in the event information display area 143. In addition to special sales information and changes in operating dates and hours as described above, the displayed event information may include, for example, coupons, new products, and recommended products. This enables a customer to easily receive event information for a particular store by simply carrying the membership card 102.

Electronic paper is used for the display 135. Because the display 135 is electronic paper, a minimal amount of power is required only when rewriting the displayed content, no power is consumed to maintain the displayed content, and little power is therefore needed to display information.

By generating a barcode 156 and displaying the barcode 156 on electronic paper (a reflective display medium), a special reader is not needed to read the membership card 102, and the member number 153 can be read quickly and easily using a conventional barcode reader (such as a red LED barcode reader).

The operating unit 136 has a scroll-up button 136a and a scroll-down button 136b, and can be used to scroll the event information displayed in the event information display area 143 of the display 135 up and down. This enables the user to change (scroll through) the displayed information if all of the event information will not fit in one screen so that the user can reliably read all event information. The operating unit 136 may be rendered in unison with the display 135 if a touch panel is used for the display 135, or it may be separate from the display 135.

The controller 137 receives the company code 151 and event information transmitted from the communication device 104. The member information and barcode 156 corresponding to the company code 151 registered in the member information table 141, and the received event information are thus automatically displayed on the display 135.

The display content of the membership card 102 is described next with reference to FIG. 8. The member information table 141 shown in FIG. 7 is stored in the membership card 102. FIG. 8A shows the content displayed on the membership card 102 when a customer (membership card 102) enters store A. In this situation the store name 152a, member name 154, member number 153a in store A (a number that is valid for store A), and the barcode 156a representation of the member number 153a are displayed in the member information display area 142 of the membership card 102, and event information for store A is displayed in the event information display area 143.

When the same membership card 102 enters store B (FIG. 8B), the store name 152b, member name 154, member number 153b in store B (a number that is valid for store B), and the corresponding barcode 156b are displayed in the member information display area 142 of the membership card 102, and event information for store B is displayed in the event information display area 143.

While not shown in the figures, when the same membership card 102 enters store C, similar information relevant to store C is displayed on the membership card 102. Depending upon the store visited by the customer, the information displayed on the membership card 102 (information that is valid for the particular store) can thus be automatically and appropriately displayed on the membership card 102.

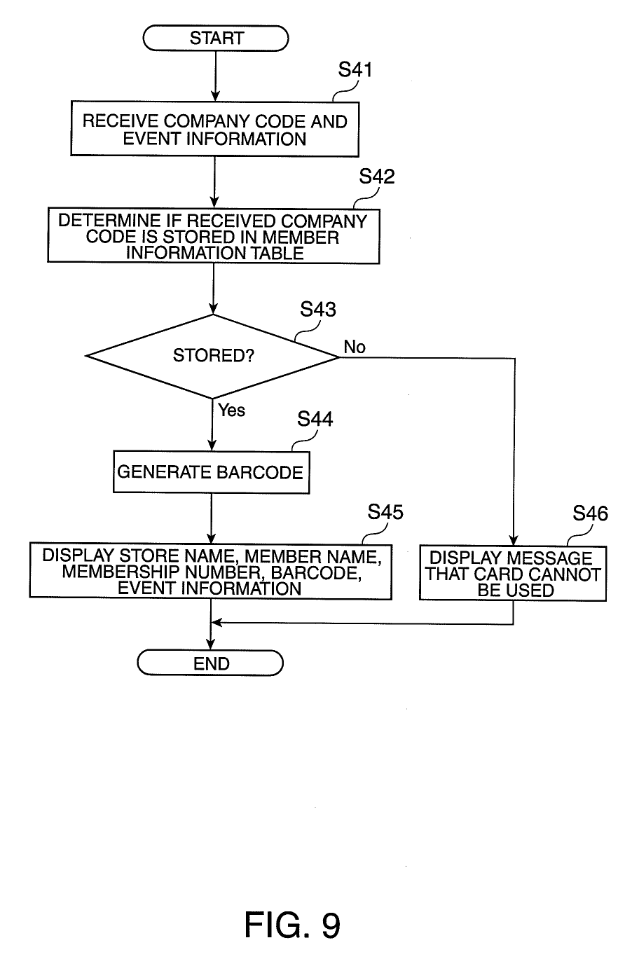

A process for displaying member information and event information on the membership card 102 is described next with reference to the flow chart in FIG. 9. The communication device 104 installed in the store constantly broadcasts corporate information (company code 151 and event information) for that store (business).

When the membership card 102 enters an area in which signals from the communication device 104 can be received, the membership card 102 receives the company code 151 and event information transmitted from the communication device 104 (S41) The event information is stored in the storage unit 133. The membership card 102 then determines if the received company code 151 exists in the locally stored member information table 141 (that is, whether the information has been stored) (S42, code identification unit).

If the company code 151 exists in the member information table 141 (S43 returns Yes), the membership card 102 converts the member number 153 into a barcode 156 based on the barcode type 155 linked to the company code 151 (S44, barcode generation unit).

The membership card 102 then displays the member information (store name 152, member name 154, member number 153), the generated barcode 156, and the event information in the storage unit 133 (S45). If the received company code 151 does not exist in the member information table 141 (S43 returns No), the membership card 102 does not display the member information (including the barcode 156) and displays a message indicating that the card cannot be used at that store (S46). The customer can thus easily know whether or not the membership card 102 can be used at the store.

As described above, the membership card 102 according to this second embodiment of the invention can display or not display member information related to the received company code 151. More specifically, member information (store name 152, member number 153, member name 154), barcode 156, and event information corresponding to the received company code 151 can be displayed, that is, displaying the member information can be turned on and off according to the company code 151. A single membership card 102 can therefore be used with a plurality of stores (businesses), a single customer that is a member at a plurality of stores does not need to carry multiple cards as is necessary with the related art, and card management is thus simplified for the customer.

Furthermore, because a single membership card 102 can be used at a plurality of stores (businesses), it is not necessary for each store to issue a unique membership card, and the cost of issuing membership cards can thus be reduced.

It should be noted that the items registered in the member information table 141 in the second embodiment of the invention are shown by way of example only, and the invention is not so limited. For example, an expiration date for the membership card 102 may be registered in the member information table 141, and the expiration date may also be displayed on the display 135. This enables the customer to easily know until when the membership card 102 can be used.

The company code 151 and event information are broadcast from the same communication device 104 in the second embodiment of the invention, but the invention is not so limited and the information can be transmitted from different devices.

A plurality of communication devices 104 may also be installed in a single store or business. In this situation the same event information may be broadcast from each communication device 104, or different event information may be transmitted.

It should be noted that while this embodiment of the invention is described using a card medium (membership card 102) as an example of a personal identification medium, the invention is not so limited. A cell phone or other mobile data device may be used as the personal identification medium, for example.

Where content is displayed on the display 135 and the position of the operating unit 136 in the foregoing embodiment are also used only as examples, and the invention is not so limited.

It will be obvious to one with ordinary skill in the related art that the invention is not limited to the foregoing embodiment and the hardware configuration and the processes of the customer information management system 101 and membership card 102 described above can be varied and improved in many ways without departing from the scope of the accompanying claims.

At least one embodiment of the invention being thus described, it will be obvious that it may be varied in many ways. Such variations are not to be regarded as a departure from the spirit and scope of at least one embodiment of the invention, and all such modifications as would be obvious to one skilled in the art are intended to be included within the scope of the following claims.

What is claimed is:

1. A personal identification medium comprising:
a personal information storage unit that stores personal information including information relating to an individual;
a display unit that displays the personal information; and
a reception unit that receives information by contactless communication from an external device, and displays or stops displaying the personal information when triggered by receiving specific information from the external device.

2. The personal identification medium described in claim 1, wherein:
the external device is installed at a prescribed location, and is used to record the time when an individual clocks in and when an individual clocks out;
the reception unit receives at least clock-in time or clock-out time information from the external device, and includes
a clock-in/clock-out time storage unit that stores the received clock-in time or clock-out time information in addition to the personal information; and
the display unit displays or stops displaying the clock-in time or clock-out time when triggered by the reception unit receiving the clock-in time or clock-out time as the specific information.

3. The personal identification medium described in claim 2, wherein:
the display unit displays at least the clock-in time when triggered by receiving the clock-in time, and
stops displaying the displayed content when triggered by receiving the clock-out time.

4. The personal identification medium described in claim 1, further comprising:
An operating unit for changing the content displayed by the display unit.

5. The personal identification medium described in claim 1, wherein:
the personal information includes member information for identifying a member in a company;
the personal information storage unit stores the member information linked to one or more company codes for identifying the company; and
the display unit displays or stops displaying the member information linked to the company code when triggered by the reception unit receiving the company code for any one of the one or more companies as the specific information.

6. The personal identification medium described in claim 5, further comprising:
a code detection unit that determines whether or not a company code exists in the information received by the reception unit;
wherein the display unit displays the member information when the code detection unit determines that a company code exists, and does not display the member information when the code detection unit determines that a company code does not exist.

7. The personal identification medium described in claim 5, further comprising:
a code generating unit that generates an encoded symbolic image;
wherein the member information includes a member number assigned to each member and a code type identifying the type of code;
the code generating unit generates the symbolic image from the member number based on the code type; and
the display unit displays the generated symbolic image as at least a part of the member information.

8. The personal identification medium described in claim 5, further comprising:
an event information storage unit that receives and stores event information related to the company from the external device;
wherein the display unit displays the event information when triggered by reception of the company code.

9. The personal identification medium described in claim 1, wherein:
the display unit is electronic paper.

10. A time and attendance management system comprising:
the personal identification medium described in claim 2; and
a time and attendance management device that transmits at least the clock-in time and clock-out time for an individual as the external device.

11. A customer information management system comprising:
the personal identification medium described in claim 5; and
a customer information management device that transmits at least the company code as the external device.

12. A display method for a personal identification medium, comprising steps of:
storing personal information including information relating to an individual in a personal information storage unit;
receiving information by contactless communication from an external device by means of a reception unit;
displaying the personal information based on the received information on a display unit; and
displaying or not displaying the personal information when triggered by receiving specific information from the external device.
